(19) United States
(12) Patent Application Publication
(10) Pub. No.: US 2017/0182694 A1
(43) Pub. Date: Jun. 29, 2017

(54) MELT PUMPS FOR PRODUCING SYNTHETIC GRANULES, EXTRUDED PROFILES OR MOLDED PARTS

(71) Applicant: HENKE Property UG (haftungsbeschränkt), Kassel (DE)

(72) Inventor: Matthias Henke, Kassel (DE)

(21) Appl. No.: 15/459,988

(22) Filed: Mar. 15, 2017

Related U.S. Application Data
(62) Division of application No. 14/565,983, filed on Dec. 10, 2014.
Application No. 14/565,983 is a continuation of application No. PCT/DE2013/000327, filed on Jun. 24, 2013.

(30) Foreign Application Priority Data
Jun. 25, 2012 (DE) 10 2012 012 444.9

(51) Int. Cl. B29C 47/00; F04C 2/08; F04C 2/16; F04C 15/00; B29C 47/36; B29B 7/48

(52) U.S. Cl. CPC B29C 47/0011; B29C 47/366; B29C 47/367; B29B 7/482; F04C 2/16; F04C 15/0073; F04C 2/084

(57) ABSTRACT

Melt pumps for producing synthetic granules, extruded profiles or molded parts are disclosed. One disclosed example melt pump for building up pressure at a fluid medium is to be used for pressing the medium through a tool. The example melt pump includes a compressor that comprises an inlet and an outlet opening, and at least two worm conveyors disposed in a common housing, where worm flights provided on the worm conveyors are configured in such a manner that a force feed of the medium occurs and where the worm conveyors are drivable by their own drive.

### RELATED APPLICATIONS

This patent arises as a divisional of U.S. patent application Ser. No. 14/565,983, filed on Dec. 10, 2014, which is a continuation of International Patent Application Serial No. PCT/DE2013/000327, filed Jun. 24, 2013, which claims priority to German Patent Application No. DE 10 2012 012 444.9, filed on Jun. 25, 2012, all of which are hereby incorporated herein by reference in their entireties.

### FIELD OF THE DISCLOSURE

This disclosure relates generally to melt pumps and, more particularly, melt pumps for producing synthetic granules, extruded profile or molded parts.

### BACKGROUND

Synthetic granules to be used for example in a synthetic injection molding machine are processed using an extrusion process. In this extrusion process a synthetic melt is generated in a worm machine, for example a compounder, an extruder, a worm kneader or a similar device for manufacturing synthetic melt. The synthetic melt can be made of plastic, as well as of renewable primary products or protein or the like. Once the synthetic melt is prepared in the worm machine, the melt is moved from the worm machine to a gear pump in order to press the melt through a tool to generate the granules. The gear pump may be expensive and create or allow a buildup, which may cause a pulsating entrance pressure. Such pulsations may require higher pressures to overcome the pulsations. Alternatively, a single screw pump is used instead of a gear pump. The single screw pump also has corresponding pulsating entrance pressures as a result of the buildup and also requires higher pressures to overcome the entrance pressures. The need for higher pressures in these devices may require more powerful motor(s), reinforced components, larger equipment, greater energy consumption, etc.

### BRIEF DESCRIPTION OF THE DRAWINGS

FIG. 1 is a top view of an example device in accordance with the teachings of this disclosure as a schematic representation with an example melt pump.

FIG. 2 is cross-sectional view of the example melt pump of FIG. 1.

FIG. 3 is a cross-sectional view of a second example melt pump in accordance with the teachings of this disclosure along a section corresponding to the line III-III of FIG. 5a.

FIG. 4 is a cross-sectional view of the example melt pump of FIG. 3 along a section corresponding to the line IV-IV of FIG. 5b.

FIGS. 5a and 5b show additional cross-sectional views of the example view pump of FIG. 3 along a section defined by the line V-V of FIG. 3.

FIG. 6 is a lateral view of a worm conveyor of a third example melt pump in accordance with the teachings of this disclosure.

FIG. 7 is a front view of a worm conveyor of FIG. 6.

FIG. 8 is a cross-sectional lateral view of the example worm conveyor of FIG. 6, in a section corresponding to the line VIII-VIII of FIG. 6.

FIG. 8a is an enlarged detail view corresponding to the circular line VIIIa of FIG. 8.

FIG. 9 is a perspective view of an example worm conveyor of a fourth example melt pump in accordance with the teachings of this disclosure.

FIG. 10 is a lateral view of the example worm conveyor of FIG. 9.

FIG. 11 is a top view of the example worm conveyor of FIG. 9.

FIG. 12 is a front view of the example worm conveyor of FIG. 9.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with one or more intermediate part(s) located there between. Stating that any part is in contact with another part means that there is no intermediate part between the two parts.

### DETAILED DESCRIPTION

The examples disclosed herein relate to devices for manufacturing synthetic granules, extruded profiles or molded parts including a melt pump for increasing pressure of a fluid medium, more specifically, synthetic melt, by pressing the medium through a tool.

To produce (e.g., manufacture) synthetic parts, a synthetic melt is first produced from different basic materials in a worm machine during a polymerization process. As described herein, synthetic parts may refer to parts that are manufactured from plastic or renewable primary products such as, for example, proteins. Such a worm machine may be a compounder, an extruder, a worm kneader and/or a similar devices to manufacture synthetic melt.

A worm machine, in which different basic materials are mixed and kneaded by means of synchronous worm shafts until a fluid synthetic melt is produced, is known for example from EP 0 564 884 A1, which is hereby incorporated by reference.

To manufacture synthetic granules, which are processed in synthetic injection molding machines, for example, the synthetic melt is pressed through a tool, which may be a perforated disc, at up to 30 bar. In order to manufacture a synthetic profile or a synthetic molded part, after the extrusion process, the synthetic melt must be pressed through a corresponding molding tool at up to 300 bar.

As known from the aforementioned EP 0 564 884 A1, the synthetic melt may be transferred from a worm machine to a gear pump such as known, for example, from DE-OS 38 42 988, which is hereby incorporated by reference, and then pressed through the tool to obtain the desired granules, profile and/or a molded part.

However, a disadvantage of a separate gear pump is its expensive production, amongst others, due to its own drive and its own required controls. Another problem of the gear pump with a distinct drive is that, more specifically, at low rotation speeds of up to 50 rpm, a design inherent pulsation is generated and a significant admission pressure, thus, bears against the pump inlet. The gear pump is sealed when the teeth of adjacent gears meet, but during the transfer of the synthetic melt to the tool, not all of the synthetic melt is pressed through the tool. The remaining synthetic melt is then brought back (e.g., backwards, etc.) by the gears towards the opening of the pump inlet, where a corresponding admission (e.g., inlet) pressure buildup occurs. Because this admission pressure is not regular, but appears only at pulsating intervals, a pulsation occurs. In order to overcome this pulsating admission pressure, the melt must be transferred at a corresponding pressure, which requires a sufficient pressure buildup at an end of the worn machine.

Instead of the gear pump, alternatively, a single screw pump with a distinct drive is commonly used. But single screw pumps also have significant design-inherent admission pressures at the pump inlet, which must be overcome by the worm machine.

Thus, using a gear pump or a single screw pump may be only advantageous in that the pressure raising unit of the worm machine can be made smaller, but elimination and/or reduction of the need to increase the pressure may not be possible because the generated admission pressure must still be overcome.

Another disadvantage of the gear pump and the single screw pump is that once the operation has ended, synthetic melt remains between the gears or in the screw channel and, thus, the gear pump or the single screw pump must be cleaned in a relatively labor-intensive manner.

The aforementioned EP 0 564 884 A1 shows integrating the gear pump into the worn machine, so that a single drive drives the worm shafts with the gear pump attached thereon. This may be advantageous in that the gear pump is operated with the same high rotation speed as the worm shafts and the resulting pulsation is, thus, reduced.

A two screw extruder with an integrated screw pump is known from EP 1 365 906 B1, which is also incorporated by reference, where two screw elements that cause a pressure increase are attached to synchronous worm shafts. Due to a specific screw design, chambers are formed between the screw elements, which allow a volumetric force-feed of the plastic melt, thereby resulting in a pressure buildup. However it is then necessary in the worm machine of EP 0 564 884 A1, as well as in the two screw extruder of EP 1 365 906 B1 to increase the size of the drive of the entire arrangement since the drive must provide force and energy for the pressure increase and the mixing and/or kneading process(es) simultaneously. Thus, a significantly more powerful electric motor and/or correspondingly reinforced gears, shafts, housings, etc. must be provided.

In the screw machine according to EP 0 564 884 A1 and in the two screw extruder according to EP 1 365 906 B1, the integrated gear pump and the screw elements causing the pressure increase have the same rotation speed as the worm shafts used for mixing and kneading. Achieving a homogeneous synthetic melt may require a high rotation speed. However, in the gear pump as well as in the screw elements causing the pressure increase, this high rotation speed generates high friction, which results in a high force and energy expenditure and high heat generation. This heat is thereby transmitted to the synthetic melt, but such heat transmission may cause a disturbance or, in extreme cases, damage of the synthetic melt. Therefore, the application spectrum of an integrated gear pump and of the special screw elements is limited. This problem is attenuated by the fact that depending on the synthetic melt used, an individually adapted gear pump or individually configured screw elements are used. The friction losses may also impact the drive and the entire arrangement, which typically require a corresponding larger size. This larger size requirement, however, typically leads to high equipment-related expenditure and high installation costs.

The examples disclosed herein are based on the finding that integrating a pressure increase unit into a worm machine is mainly possible with an increased equipment-related expenditure and that compromises usually must be made with regard to the pressure increase unit and to the worm machine, and, thus, these components may not be optimally designed.

Another finding is that when operating a worm machine with a pressure increase unit, excessive undesired friction heat may generated that is often complicated to counteract.

Based on this, the object of the examples disclosed herein is to create a device to manufacture synthetic granules, extruded profiles and/or molded parts, in which the worm machine operates without a pressure increasing unit and/or components.

However, a pressure increase unit such as a melt pump, must be developed to avoid the disadvantages of the aforementioned gear pump or the single screw pump, and, thus, reduce the pulsation and the admission pressure to a minimum.

In the context of resolving these concerns, it has been discovered that a force-feed of the fluid medium causes the medium to be permanently transported away from the inlet opening of the melt pump, which results in a reduction and/or absence of an admission pressure at the inlet opening.

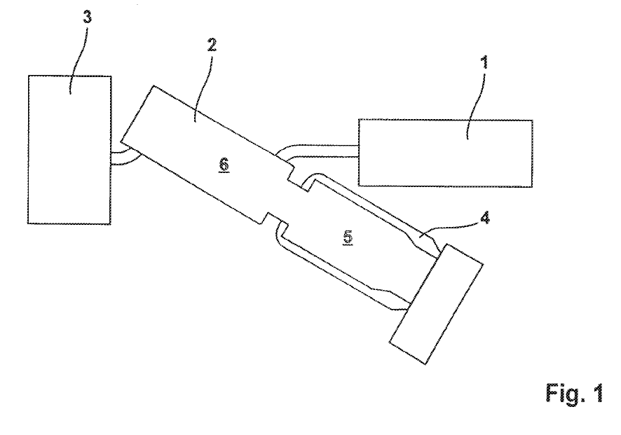

As set forth herein, FIG. 1 schematically shows an example device for manufacturing synthetic granules, plastic profiles or plastic molded parts with a worm machine 1 to mix and knead the basic materials into synthetic melt. The example device includes an example melt pump 2 according to the examples disclosed herein to compress the synthetic melt and a tool 3, which is a perforated disc, through which the synthetic melt compressed at 50 bar is pressed to produce the desired synthetic granules. In some examples, an extrusion tool for manufacturing the desired synthetic profiles or the desired synthetic molded parts is used instead of the perforated disc, where a pressure of more than 250 bar must bear against the tool.

In this example, the melt pump is disposed at an angle of 45° relative to the worm machine to reduce the space necessary at a production facility.

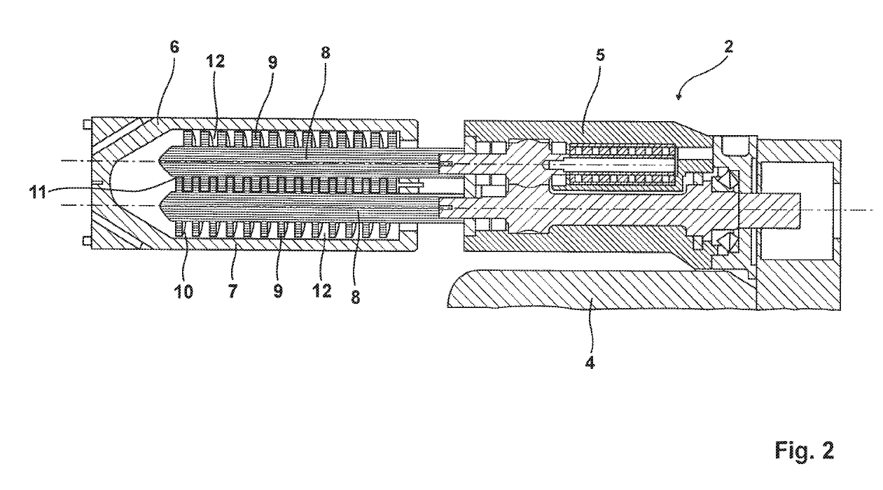

As can be gathered more specifically from the illustrated example of FIG. 2, the melt pump 2 comprises a drive that is an electric motor 4, a gear 5, and a compressor 6. Two worm conveyors 8 of the illustrated example are disposed relatively parallel to the housing 7 of the compressor 6 and rotate in opposite directions to one another. In this example, the worm conveyors 8 are connected to the gear 5, which, in turn, is connected to the electric motor 4. Each of the two worm conveyors 8 of the illustrated example has a substantially radially protruding, worm-shaped circumferential worm flight 9, in which the worm flight 9 of one of the worm conveyor 8 engages with the worm flight 9 of the other worm conveyor 8 in such a manner to enable a force-feed of the synthetic melt to occur.

In the first example melt pump 2 shown in FIG. 2, the two worm conveyors 8 rotate in opposite directions to one another. In order to ensure a correct, reciprocally accurate engagement of the worms with one other, the worm conveyors 8 are permanently coupled via the gear 5 so that a synchronous operation of the worm conveyors 8 is ensured. Both worm conveyors 8 of the illustrated example are, thus, driven synchronously.

In this example, the housing 7 is formed to correspond with the worm conveyors 8 in such a manner that a narrow housing gap 10 remains between the outer edge of the worm flight 9 and the housing 7, whereby the narrow housing gap 10 can be between approximately 0.05 millimeters (mm) and 2 mm. In this example, the narrow housing gap is 0.5 mm.

The radially protruding worm flight 9 and a flank angle on each side of the worm flight 9 of approximately zero degrees with plane flanks and, more specifically, a plane flight surface results in a worm flight 9 having a significantly rectangular cross-section. At the same time, the distance between adjacent worm flights 9 of the illustrated example corresponds to the width of the worm flight 9. As a result, the worm flight 9 of the one worm conveyor 8 precisely fits into the interval of the worm flight 9 of the other worm conveyor 8. Thus, the worm gap 11 remaining between the worm flights 9 and the worm conveyors 8 is reduced (e.g., reduced to a minimum) and is approximately between 0.05 mm and 2 mm, and preferably 0.5 mm. The actually desired worm gap 11 depends on the type of medium used, in which the worm gap 11 may be increased as the medium viscosity increases.

Due to the worm gap 11 being reduced (e.g., reduced to a minimum), a seal may be formed between the adjacent worm conveyors 8 so that a number of worm chambers 12 are formed between the housing 4, the worm flights 9 and the worm conveyors 8, where each worm chamber 12 is closed by the seal (e.g. the worm gap acting as a seal) and the synthetic melt contained therein is continuously conveyed. Due to the tightly cogged worm conveyors 8, a reflux of a part of the synthetic melt is reduced (e.g., reduce to a minimum) so that the pressure loss is also reduced (e.g., reduced to a minimum), for example. In some examples, this is referred to as being axially sealed.

In order to achieve a high conveying output, the worm chambers 12 of the illustrated example are designed to be relatively large. This may be achieved by high worm flights 9, where the ratio of the outer diameter (Da) to the core diameter (Di) is approximately equal to 2.

In order to implement a relatively small construction size of the melt pump 2, the worm conveyors 8 of the illustrated example have an approximate length/outer diameter ratio of 3.5.

In this example, the worm chambers 12 formed inside the housing 7 are limited outward by the housing 7 and laterally by the worm flight 9. In the area where the worm flights 9 of neighboring worm conveyors 8 engage with one another, the worm chambers 12 are separated by the sealing effect. Thus, in this example, a single worm chamber 12 extends along one worm channel.

The design of the width of the housing 10 and/or the worm gap 11 may be dependent on the materials used. For example, when processing highly filled plastics with a calcium carbonate proportion of 80% at a required pressure of 250 bar, a width of 0.5 mm has proven to be advantageous. With a medium having a higher fluidity, the gap is made smaller, and with a medium with a lower fluidity, the gap is made larger. In examples with hard particles where fibers or pigments are mixed into the medium, the gap can also be designed to be larger.

Thus, the housing gap 10 and the worm gap 11 of the illustrated example allow for the formation of the quasi closed worm chamber 12, whereby a pressure buildup toward the perforated disc 3 is achieved, amongst others, because of a significant reflux of the medium being prevented.

In case the pressure locally exceeds the desired amount, the gap acts as a compensation because some of the synthetic melt can escape into the adjacent worm chamber 12, which lowers the local pressure and may prevent obstruction and/or damage. Thus, the size of the gap also impacts the pressure compensation.

In some examples, if a higher pressure is required in the tool 3, the housing gap 10 and the worm gap 11 should and/or must be reduced. This also applies to examples in which a highly viscous synthetic melt is processed. With a synthetic melt of low viscosity, the gap may also be broadened. As a result, the gap should and/or must be chosen for each particular example according to the criteria described herein. A gap width between 0.05 mm and 2 mm has shown to be advantageous. Some of the examples described herein are axially sealed.

The examples of the melt pump 2 having a gap width of 0.5 mm described herein may be used particularly advantageously for highly filled synthetics (e.g., for plastics with a high solid content, such as calcium carbonate, wood or carbide). Thus, the highly filled synthetic may have a calcium carbonate proportion of approximately at least 80%.

Due to the multiplicity of synthetic melts, the flank angles, which are also called profile angles, may be adapted into any required form. Thus, it has proven advantageous, at least with counter-rotating worm conveyors 8, for example, to select a rectangular thread profile as shown in FIG. 2 or a trapeze-shaped thread profile as shown in FIG. 8.

Rectangular thread profiles as shown in FIG. 2 may also be used to process polyethylene (PE).

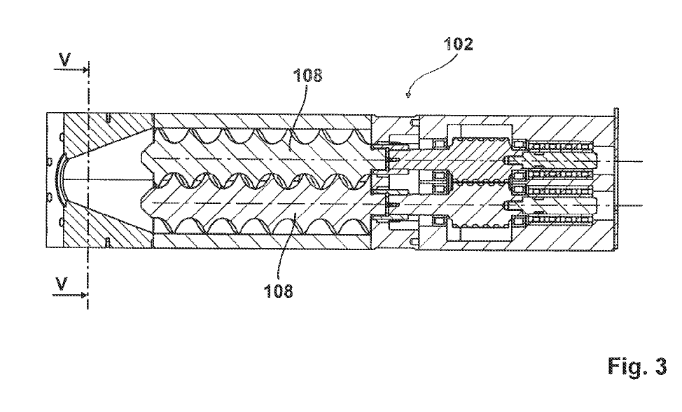

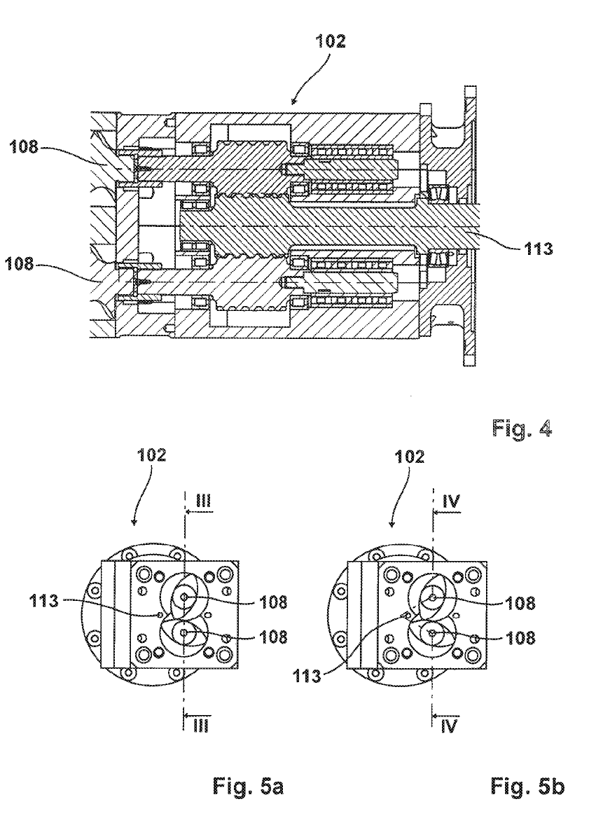

In the second example of a melt pump 102 according to the examples described herein of FIGS. 3-5, the two worm conveyors 108 rotate in the same direction and are driven by a common drive shaft 113. In this example as well, the worm flights 109 of the worm conveyors 108 engage with each other in a manner that a minimal worm gap remains.

These types of highly filled synthetics may be transported and compressed by the melt pump 2, 102 in a material preserving manner, where the melt enters the melt pump 102 at atmospheric pressure and exits the melt pump 102 at a pressure of 50 bar to 600 bar, preferably 400 bar. In this example as well, the ratio of Da to Di is approximately equal to 2 to achieve a high conveying output.

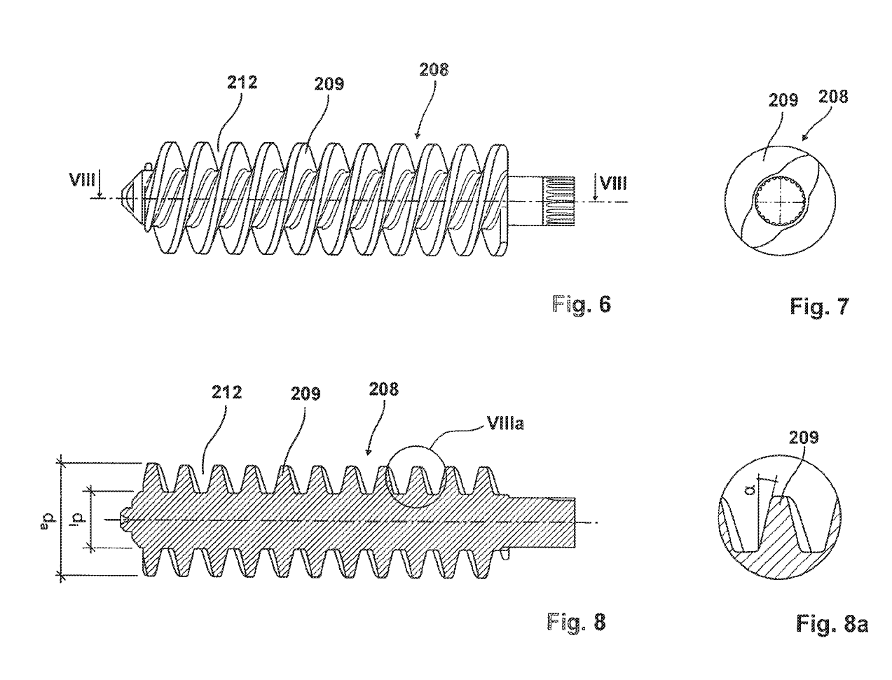

In FIGS. 6-8, a worm conveyor 208 of a third example melt pump according to the examples disclosed herein is shown. The worm conveyor 208 of the illustrated example is double-threaded and its worm flights 209 are designed with substantially trapeze-shaped cross-section with a flank angle of approximately 13°. In this example, the worm conveyor 208 is used in a counter-rotating manner and used, preferably, for processing PVC. In this example as well, axially sealed worm chamber 212 are formed, which enable a preferable pressure buildup and a preferable force-feed. In this example, the ratio of Da to Di is approximately equal to 2.

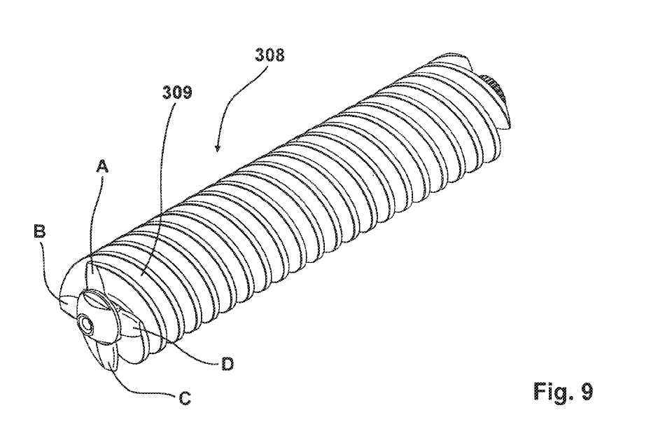

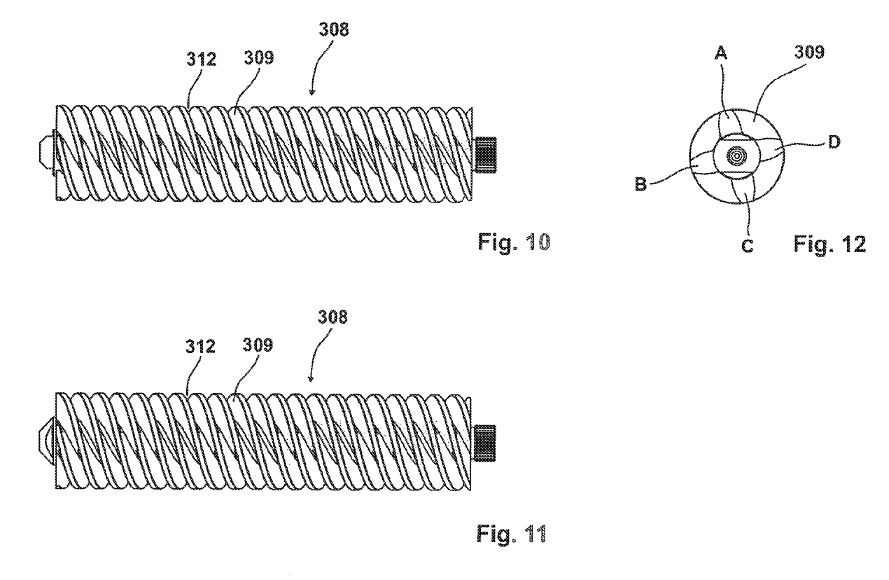

In FIGS. 9-12, a worm conveyor 309 of a fourth example melt pump according to the examples disclosed herein is shown. This worm conveyor 308 is quadruple threaded (A, B, C, D) and its worm conveyors 309 have a rectangular cross-section with a flank angle of approximately 0°. This worm conveyor 308 is used in a counter-rotating manner and is preferably used for processing a medium containing proteins. In this example, axially sealed worm chambers 312 are formed, which achieve a good pressure buildup and a good force-feed. In this example, the ratio of Da to Di is approximately equal to 2.

According to the examples disclosed herein, a device for manufacturing synthetic granules, extruded profiles or molded parts with the features of claim 1 and a melt pump with the features of claim 3 is proposed as one of the example technical solutions to this object. Advantageous developments of this device and this melt pump may be gathered from the examples disclosed herein.

A device designed according to examples disclosed herein and a melt pump designed according to examples disclosed herein are advantageous in that due to the melt being force-fed in the melt pump, there is little or no significant admission pressure at the inlet opening of the melt pump so that the melt may transition with relatively little or no significant pressure resulting from the worm machine to the melt pump.

In this example, mainly the forces required to transport the synthetic melt, for example, and to overcome the inertia of the melt, the friction, etc. must be applied by the worm machine and can lead to a slight pressure increase depending on the composition of the melt. Such forces may, however, be applied by the worm of the worm machine itself such that a pressure increase device in the worm machine may be reduced and/or eliminated. This is, in turn, advantageous such that a worm machine may be operated without a pressure increase device with a smaller drive, in particular a smaller electric motor, and where appropriate a smaller drive, a smaller worm, a smaller housing and/or other smaller components because transferred forces are significantly reduced. This may lead to a significant reduction of the manufacturing costs of the worm machine and/or reduction of associated energy costs.

Furthermore, not using a pressure increase device advantageously enables the worm machine to be consistently designed for mixing the basic materials and to produce synthetic melt, which improves the efficiency and, thus, the overall cost-effectiveness of the worm machine.

Another advantage is that after separating the melt pump from the worm machine, the melt pump may be constructed and designed solely for achieving an effective pressure increase.

Unexpectedly, it has turned out that when constructing and operating a prototype in accordance with the teachings of this disclosure, a sum of the electrical power of the drives of the worm machine and of the melt pump were reduced relative to the electrical power of a corresponding device of known examples. Thus, by separating the worm machine and the melt pump, a reduction of the energy costs for manufacturing the synthetic granules, the extruded profiles and the molded parts was achieved in addition to a reduction of the manufacturing costs of the device resulting from components with reduced sizes.

In one advantageous example, worm conveyors are configured in such a manner that the ratio of the outer diameter relative to the core diameter is approximately 2. Depending on the type of synthetic melt a ratio between Da and Di having a range of approximately between 1.6 and 2.4 may also be chosen, thereby resulting in a large delivery volume achieved with a relatively thin and, thus, cost-effective worm.

In another advantageous example, the worm flights have a rectangular or trapeze-shaped thread profile to allow an effective force feed of the melt to be achieved, more specifically when the flank angle (also called profile angle) is chosen between approximately 0° and 20°. The design of these worm flights may be adapted to the melt to be used. For example, a profile angle of 0° has proven to be of value when processing Polyethylene (PE), whereas PVC has been shown to be better processed with a profile angle of 13°.

In another preferred example, the worm flight has a plane surface, which also contributes to a cost-effective production.

In the example of the worm flight with a plane flank, a flank angle of 0° and a plane surface, the worm flight has a rectangular cross-section. More specifically, when the interval of the worm flights after each pitch corresponds roughly to the width of the worm flight, a significantly uniform gap between flights may be achieved, which is reduced to a minimum, by which the corresponding worm chamber is sealed off. Such a seal allows for a high pressure buildup on the tool and, more specifically, on the perforated disc.

In another advantageous example, two worm conveyors are disposed above one another (e.g., vertically relative to each other). This is advantageous in that the inlet opening can be arranged centrally relative to the worm conveyors so that the incoming melt is well-captured by both worm conveyors and, thus, a relatively high filling degree is achieved. This is additionally advantageous in that the inlet opening may be disposed laterally on the melt pump so that a radial inlet and a radial outlet of the medium occur. This, in turn, allows for an angled arrangement of the melt pump relative to the worm machine, where the advantage is that the total length of the device may be reduced. The melt pump can, for example, be set up at an angle of approximately 45° relative to the worm machine, which leads to significant corresponding space savings.

In another advantageous example, the melt pump is designed in such a manner that the worm conveyors rotate at rotation speeds between approximately 30 rpm and 300 rpm, preferably at rotation speeds between 50 rpm and 150 rpm, depending on the type of the synthetic melt. This is advantageous in that, at least in most typical examples, the chosen rotation speed lies above the rotation speed of a gear pump or a single screw pump so that in the context of the force-feed of the melt due to geometry, the melt is conveyed with significantly reduced or no pulsation.

An advantage of a rotation speed limited to a maximum of 300 rpm is that the shear of the polymer chains occurring at a high rotation speed may be avoided.

In another example, a gear is disposed between the compressor and the advantageously electrical drive, by way of which the worm conveyors are synchronously drivable. A reciprocal, geometrically accurate interlock of the worm flights is possible because of the synchronization. The second worm is thereby advantageously not moved along by a mechanical forced coupling as in geared pumps from known examples but rather directly driven, so that high friction with the known disadvantages of high energy consumption and an inevitably associated temperature increase is avoided. This also makes it possible to operate the worm conveyors so that they rotate in opposite directions. The synchronization from the gear is furthermore advantageous in that drive forces also can be introduced directly into both worm conveyors, in order to achieve a better force distribution.

In another preferred example, the worm flights of both worm conveyors engage with each other in such a manner that the flight gap remaining at the narrowest location forms a gap seal. This gap seal prevents the reflux of the medium and increases the force feed and also acts as overpressure compensation. The force feed generates a high pressure buildup and, simultaneously, the pressure compensation prevents damage to the medium, more specifically when the gap seal is adapted to the medium to be processed. The same advantages may also apply to the housing gap.

Another advantage is that the two worm conveyors may be driven with relatively low output, which leads to a smaller drive motor and a lesser energy consumption.

In another preferred example, a number of worm chambers, in which the medium is contained, are formed between the housing and the worm conveyors or their worm flights. The worm chambers are thereby designed to be quasi closed in accordance with the gap seal of the worm and/or housing gap so that the desired pressure may be built up but that in examples with a locally excessive pressure, compensation of the pressure occurs.

In a preferred example, a worm chamber extends along the pitch of a worm flight. The beginning and the end of the worm chamber are thereby located at the intersection of the two worm conveyors (e.g., in the plane defined by the axes of the two worm conveyors). This is advantageous in that the medium occupies a defined place and is not mixed with another medium. At the same time, this allows for an efficient pressure build up on the perforated disc.

In yet another preferred example, a housing gap is formed between the worm flight and the casing, and a worm gap is formed between the worm flight and its adjacent worm conveyor, which both form a gap seal, so that the medium is substantially held in the respective worm chamber without a significant reflux of the medium occurring through the gaps (e.g., gap seal) into an adjacent rearward worm chamber. This is advantageous in that a seal is achieved between the worm chambers, which allow for a high pressure in each worm chamber and a pressure of more than 400 bar and up to 600 bar on the perforated disc.

In yet another preferred example, the housing gap and/or the worm gap has a width between approximately 0.05 mm and 2 mm. The width of the gap and, thus, the size of the gap seal ultimately dependent on the medium to be processed and its additives. A gap of approximately 0.5 mm has proven advantageous for highly filled plastics with a calcium carbonate proportion of 80% and a pressure of 500 bar on the perforated disc.

In a preferred example with a length/diameter ratio of the worm conveyor of 2 to 5, preferably 3.5, the melt pump may achieve a pressure of more than 250 bar and up to 600 bar on the perforated disc. This is advantageous in that the melt pump can be manufactured at low cost and utilized in a space-saving manner.

Yet another advantage is that a relatively quick pressure buildup is achieved due to the cooperation of the two accurately interlocking worm conveyors with the correspondingly configured worm flights and the force-feed so that with a relatively short construction of the melt pump, high pressures may be achieved, the retention period in the melt pump may be relatively small, and the thermal and mechanical damage to the melt is thus

Other advantages of the disclosed example devices and melt pump in accordance with the teachings of this disclosure may be gathered from the enclosed drawings and the examples disclosed herein. According to the examples disclosed herein, the afore-mentioned features and those developed in the following can also be used individually or in any combination of each other. The mentioned embodiments must not be understood as an exhaustive enumeration but rather as examples. In the drawings:

From the foregoing, it will be appreciated that the above disclosed methods, apparatus and articles of manufacture allow relatively less costly equipment, potential energy savings and/or less use of needed production space.

This patent arises as a divisional of U.S. patent application Ser. No. 14/565,983, filed on Dec. 10, 2014, which is a continuation of International Patent Application Serial No. PCT/DE2013/000327, filed Jun. 24, 2013, which claims priority to German Patent Application No. DE 10 2012 012 444.9, filed on Jun. 25, 2012, all of which are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A melt pump for building up pressure at a fluid medium, the melt pump for pressing the medium through a tool, comprising:
a compressor that comprises an inlet and an outlet opening; and
at least two worm conveyors disposed in a common housing, wherein worm flights provided on the worm conveyors are configured in such a manner that a force feed of the medium occurs and wherein the worm conveyors are drivable by their own drive.

2. The melt pump as defined in claim 1, wherein the worm conveyor is configured to have a ratio between the outward diameter (Dₐ) and the core diameter (Dᵢ) is approximately between 1.6 and 2.4.

3. The melt pump as defined in claim 1, wherein the worm flight has a rectangular or trapeze-shaped thread profile.

4. The melt pump as defined in claim 3, wherein the worm flight has a profile angle approximately between 0° and 20°.

5. The melt pump as defined in claim 1, wherein the two worm conveyors are disposed vertically relative to one another.

6. The melt pump as defined in claim 1, further comprising a gear provided between the drive and the compressor, wherein the worm conveyors are synchronously drivable.

7. The melt pump as defined in claim 6, wherein the drive and the gear have a rotation speed of the worm conveyors between approximately 30 rpm and 300 rpm.

8. The melt pump as defined in claim 1, wherein the worm flights and the worm conveyors are configured so that they correspond to one another and engage with one another in such a manner that between the housing and the worm conveyors with their worm flights at least one worm chamber is established, which is closed except for a housing gap and/or a worm gap.

9. The melt pump as defined in claim 1, wherein the housing is configured to correspond to the outer contour of the worm conveyors in such a manner that a housing gap between the worm conveyor and the housing is small enough to enable the housing gap to establish a gap seal and the worm flights and the worm conveyors are formed so that they correspond to one other and disposed so that they engage with each other in such a manner that a worm gap remaining between the worm flight and the worm conveyor is small enough for the worm gap to establish a gap seal.

10. The melt pump as defined in claim 9, wherein one or more of the housing gap or the worm gap is chosen dependent on the medium so the compressor is substantially axially sealed.

11. The melt pump as defined in claim 1, wherein the worm conveyors are configured to rotate in opposite directions to one another.

12. The melt pump as defined in claim 1, wherein a worm conveyor of the worm conveyors has a length to outer diameter ratio between approximately 2 and 5.
